(19) United States
(12) Patent Application Publication
(10) Pub. No.: US 2018/0225793 A1
(43) Pub. Date: Aug. 9, 2018

(54) SYSTEM AND METHOD FOR IDENTIFYING EVIDENCE OF ACCOMPLISHMENT FOR LAWYERS AND LAW FIRMS PRACTICING IN FEDERAL COURT

(71) Applicant: Jeremiah Richard Jones, Pompano Beach, FL (US)

(72) Inventor: Jeremiah Richard Jones, Pompano Beach, FL (US)

(21) Appl. No.: 15/424,800

(22) Filed: Feb. 4, 2017

(51) Int. Cl. G06Q 50/18; G06Q 10/06

(52) U.S. Cl. CPC G06Q 50/18; G06Q 10/06398

(57) ABSTRACT

The present invention provides a system and method for identifying accomplishment in the legal profession for lawyers and law firms who litigate cases in federal court. In one embodiment, a candidate pool database is created by identifying lawyers and law firms associated with substantive written opinions decided by federal judges. Lawyers and law firms receiving favorable written opinions are then assigned numerical point totals based on the importance of the written opinion in the specific litigation as well as the significance it may have on the legal profession. Lawyers and law firms are then ranked based on their point totals and are recognized as demonstrating accomplishment in the legal profession for those litigating cases in federal court.

### BACKGROUND

### Field of the Invention

The present invention relates to a system and method for identifying accomplishment in the legal profession for lawyers and law films who litigate cases in federal court. Specifically, the present invention relates to a system and method that identifies lawyers and law firms that obtain more favorable substantive written opinions from federal judges than those of their peers and presents these lawyers and law firms as possessing objective evidence of accomplishment in the legal field to the legal community as well as other interested parties.

### Description of the Related Art

Most awards within the legal profession are issued by lawyer rating services. Lawyer rating services are generally known to base their decisions for issuing such awards on what is referred to in the industry as “peer recognition.” Peer recognition typically consists of two phases: (1) a “balloting process,” and (2) a “peer review process.”

With respect to the balloting process, lawyers are nominated by fellow lawyers based on their professional reputations. Lawyers submit the names of who they believe have obtained professional achievement to the lawyer rating service via electronic or written ballots. Once the lawyer rating service has received a sufficient amount of ballots, the balloting process is then followed by the peer review process.

With respect to the peer review process, the lawyer rating service often employs “peer evaluators” to review the submitted ballots. Peer evaluators often request nominated lawyers to self-report their own accomplishments and credentials for evaluation. Once received, peer evaluators may—at their discretion—verify submitted information through online research mechanisms or other methods, such as written inquiries. On the other hand, peer evaluators may choose not to verify the self-reported information at all. Peer evaluators then assign various points to nominated lawyers based on both verified and unverified self-reported information.

Both the balloting process and the peer review process make peer recognition an inherently subjective and unreliable system and method for recognizing accomplishments within the legal profession. This is especially true for lawyers litigating in federal court where sufficient objective evidence of accomplishment exists.

With respect to the balloting process, subjectivity is unavoidable. For instance, some examples of subjectivity occurring during the balloting process include: (1) a friend, family member, or co-worker nominates the lawyer; (2) a lawyer nominates the lawyer without actually having any knowledge of the lawyer's performance; (3) a lawyer is asked to nominate the lawyer, but then exercises poor (or no) judgment in evaluating the lawyer's performance prior to doing so; (4) lawyers may aggressively solicit their own nomination; (5) a lawyer may choose not to nominate another lawyer that practices in the same area of law and geographical legal market for competitive reasons; (6) lawyers make arrangements to vote for one another in a quid pro quo; and (7) a large percentage of lawyers simply have no interest in peer recognition awards and fail to participate in the balloting process at all.

These examples of inherent subjectivity and unreliableness in the balloting process, among others not mentioned here, substantially limit the candidate pool that is presented to the peer evaluators for the peer review process. Yet, most lawyer rating services imply that nominated lawyers have been selected from among all practicing lawyers, even lawyers choosing not to participate in the balloting process at all (e.g., a lawyer rating service may claim that “only 5% of all practicing lawyers are selected by it to receive an award”). As a result, peer evaluators are crediting achievement only to the small percentage of the legal community that chooses to participate in the balloting process. Thus, there is a need for a system and method that evaluates accomplishment within the legal profession for those that practice in federal court that creates a more complete candidate pool database without the need for a balloting process.

With respect to the peer review process, subjectivity is lessened, but still prevalent. During the peer review process, peer evaluators typically consider a wide range of self-reported accomplishments and credentials, such as: (1) publications or writings; (2) speaking engagements and lectures; (3) board certifications and court admissions; (4) professional memberships and affiliations; (5) jury verdicts, judgments, and settlements; (6) representative clients (i.e., notable clientele, such as public figures or large business entities); (7) a position held within a law firm (e.g., partner); (8) education and years of experience; (9) volunteer work; and (10) a lack of disciplinary history. Peer evaluators then, at their discretion, verify certain credentials through online research mechanisms, or other methods such as written inquiries. If the credentials are verified or otherwise accepted as valid, then various points are assigned to the nominated lawyer. The lawyer's points are then totaled and compared with other lawyers within a candidate pool.

The peer review process adds another two layers of subjectivity to the already inherently subjective and unreliable balloting process. First, the nominated lawyer has no incentive to self-report negative information. For example, a lawyer may decide to self-report an exceptional jury verdict, but then omit to disclose a number of substantial unfavorable jury verdicts. Such omissions leave peer evaluators with no knowledge of negative information about the lawyer. Second, with so many variants of self-reported accomplishments and credentials under consideration in the peer review process, the conclusion of peer evaluators becomes highly distorted. For example, there is limited value in comparing and contrasting a lawyer self-reporting a number of accomplishments and credentials (e.g., an experienced law partner that is often published) to another lawyer self-reporting a completely different set of accomplishments and credentials (e.g., an experienced associate lawyer with many high dollar judgments). Thus, there is a need for a system and method for evaluating accomplishment within the legal profession for lawyers who practice in federal court that is based on a single objective measure of accomplishment.

Neither the balloting process nor the peer review process of peer recognition is necessary for identifying objective evidence of accomplishment in the legal profession for lawyers who litigate in federal court. Rather, a more useful system and method for evaluating these particular lawyers is one that identifies and distinguishes lawyers who obtain more favorable outcomes for their clients than their peers.

### SUMMARY OF THE INVENTION

One aspect of the present invention includes a system and method for identifying objective evidence of accomplishment in the legal profession for lawyers who litigate cases in federal court. An embodiment of the invention includes objective rules and methodologies for evaluating lawyers that remove the need for a balloting process as well as any exercise of subjective discretion in the peer review process.

Recognizing the zero-sum aspect of litigation, the present invention clearly defines what constitutes objective evidence of accomplishment in the legal profession for lawyers who practice in federal court. More specifically, one embodiment of the invention defines objective evidence of accomplishment as a favorable “written opinion,” decided by a federal judge, that either: (1) grants the relief the lawyer requested, or (2) denies the relief requested from an opposing lawyer. The system and method only considers “written opinions” entered by federal administrative courts, the Court of Federal Claims, the United States District Courts, the United States Courts of Appeal, and the Supreme Court of the United States. The decisions made by federal judges within these “written opinions” serve as the only objective evidence of accomplishment in the legal profession for lawyers that litigate in federal courts.

An embodiment of the present invention then assigns an amount of numerical points to a lawyer who receives a favorable “written opinion” based on a pre-determined formula. An embodiment also tracks the numerical points that a lawyer could have been assigned had the “written opinion” been favorable. A further embodiment of the invention also attributes these values to the lawyer's associated law firm.

In one embodiment of the invention, the present invention places these lawyers and law firms into a candidate pool database. Another embodiment of the invention continues to monitor all lawyers and law firms within the candidate pool throughout an evaluation period (e.g., a year) for subsequent “written opinions” attributable to these lawyers and law firms.

Finally, throughout the evaluation period and when the evaluation period has ended, an embodiment ranks the lawyers and the law firms in the candidate pool database based on, for example: (1) the total points assigned to the lawyer or law firm, or (2) based on the lawyer's or law firm's favorable “written opinion” percentage (i.e., total points/total points possible). A further embodiment places the results of the rankings on an interactive website where lawyers and other interested parties may review the candidate pool database and rankings throughout the evaluation period or at the end of the evaluation period.

The present invention is further described with reference to the following detailed descriptions and its related drawing.

### BRIEF DESCRIPTION OF THE DRAWING

FIG. 1 is a flowchart illustrating a method and system for identifying objective evidence of accomplishment in the legal profession for lawyers practicing in federal court according to an embodiment of the invention.

### DETAILED DESCRIPTION

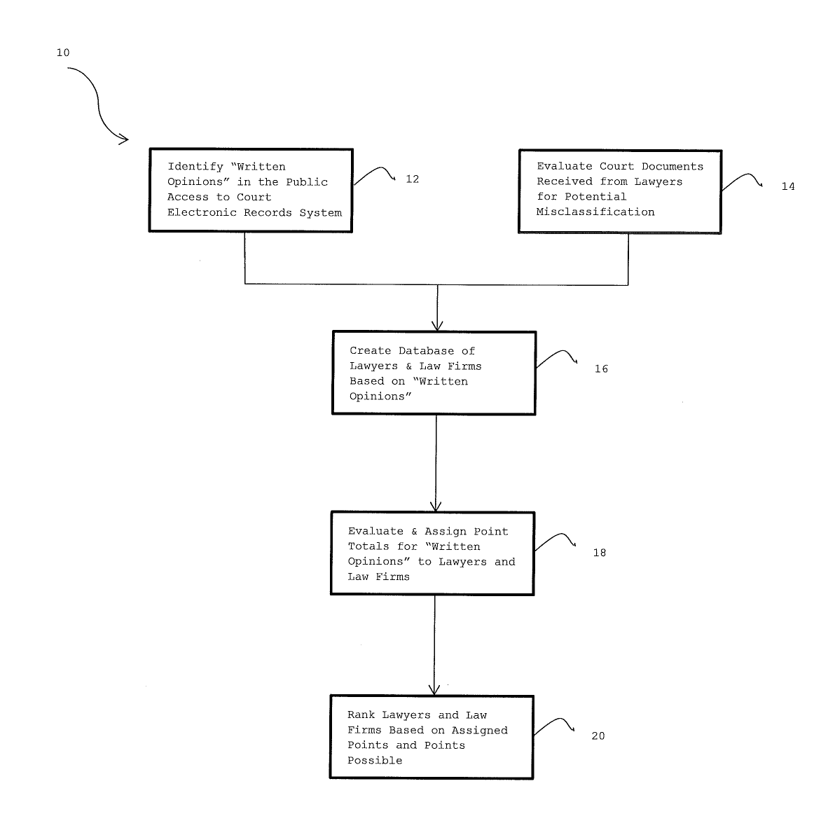

FIG. 1 depicts a flowchart for one embodiment of the system and method for identifying objective evidence of accomplishment within the legal profession for lawyers practicing in federal court. Method 10 includes the following steps: (1) identify “written opinions” on the Public Access to Court Electronic Records (“PACER”) system, or similar online systems such as court websites 12; identify self-reported “written opinions” received from lawyers that were inadvertently misclassified as not being “written opinions” in the PACER system, or similar online systems such as court websites 14; create a database of the lawyers and law firms representing the parties in these “written opinions” 16; evaluate the “written opinions” and assign numerical points to the winning lawyers and law firms based on a pre-determined formula 18; and assign a ranking to each lawyer and law firm based on the numerical points assigned to the lawyer or law firm, including an overall ranking as well as a ranking for sub-groups (e.g., area of law, geographical location, or a specific federal court) 20.

In order to prevent assigning numerical point values to lawyers for unimportant or unnecessary motion practice, one embodiment of the invention limits the objective evidence of accomplishment to substantive written opinions. The term “written opinion” as used herein refers to the term as it is used in the E-Government Act of 2002, 44 U.S.C. § 101, et seq. (the “Act”). Section 205 of the Act provides that each federal court shall provide electronic “[a]ccess to the substance of all written opinions issued by the court, regardless of whether such opinions are to be published in the official court reporter, in a text searchable format.” The Judicial Conference has interpreted the term “written opinion,” as it is used in the Act, to mean “any document issued by a judge or judges of the court sitting in that capacity, that sets forth a reasoned explanation for a court's decision.” The Judicial Conference has also stated that the authority to determine what constitutes a “written opinion” rests with the deciding judge. Thus, these “written opinions” are required to be flagged as such in the PACER system by the deciding judge.

Step 12 for identifying written opinions in the PACER system includes manually or automatically retrieving court documents flagged as written opinions by the deciding judge. As such, an embodiment of the invention retrieves written opinions from federal administrative courts, the Court of Federal Claims, United States District Courts, United States Courts of Appeal, and the Supreme Court of the United States through the PACER system, or similar online systems such as court websites.

Step 14 for evaluating self-reported court documents received from lawyers that may have been misclassified as not being written opinions in the PACER system includes using a panel of evaluators that implement objective rules and methodologies for determining whether the court document was in fact misclassified. In one embodiment, a lawyer may submit a court document that the lawyer believes sets forth a written opinion that has not been flagged as a written opinion by the deciding judge. A further embodiment allows a panel of evaluators to decide whether the court document should be reclassified as a written opinion based on the same objective standards set forth by the Judiciary Committee.

An example of an objective standard used by the panel of evaluators to reclassify court documents as written opinions is Black's Law Dictionary's definition of “opinion.” Black's Law Dictionary defines “opinion” as “[a] court's written statement explaining its decision in a given case, usu. including the statement of facts, points of law, rationale and dicta.” As such, one embodiment of the invention allows a panel of evaluators to reclassify a court document as a written opinion when it contains either a statement of facts, points of law, rationale, dicta or other indicia of a reasoned opinion. In a further embodiment, in the event the panel of evaluators reclassifies a court document as a written opinion under these objective standards, the court document is to be treated as a written opinion for all purposes of the present invention.

Step 16 involves creating a candidate pool database of the lawyers and law firms representing the parties in the written opinions identified in step 12 through step 14. The database might consist of various identifiers for lawyers, such as: (1) name; (2) contact information; (3) bar number; (4) associated firm; and (5) the point totals described below in step 18. Similar identifiers might be used for law firms, such as: (1) firm name; (2) contact information; (3) firm size; (4) associated lawyers; and (5) the point totals as described below in step 18.

Step 18 evaluates each written opinion and assigns numerical points to lawyers and law firms based on a pre-determined formula. An embodiment of the invention is that these point totals are greater for written opinions that decide the outcome of the litigation or make significant progress towards deciding the outcome of the litigation. Another embodiment also assigns greater point totals for written opinions that have regional or nationwide significance in the legal field.

For example, a written opinion deciding: (1) less important legal issues, such as a motion to strike or to compel discovery, may carry a total of 20 points possible; (2) a motion to dismiss for failure to state a claim upon which relief may be granted may carry a total of 25 points possible if it is dismissed without prejudice, or 100 points if it is dismissed with prejudice; (3) a motion for class certification may carry a total of 50 points possible; (4) a motion for summary judgment may carry a total of 100 points; (5) a motion for injunctive relief may carry a total of 25 points if it is for temporary relief, or 100 points if it is for permanent relief; (6) a motion for declaratory judgment may carry a total of 100 points if the scope of the injunction governs only the parties, or 200 points if the scope of the injunction is nationwide (i.e., such as in the case of challenging an invalid federal regulation); (7) an appellate brief to a United States Circuit Court of Appeals may carry a total of 300 points; and (8) an appellate brief to the Supreme Court of the United States may carry a total of 450 points.

A further embodiment of the present invention may assign these pre-determined numerical point totals differently depending on whether the written opinion is entered by a United States District Court, a United States Court of Appeals, or the Supreme Court of the United States.

For example, one embodiment allocates numerical point totals for written opinions at the United States District Court level based on the lawyer's success in filing a particular motion or defending against another lawyer's motion. For example, if the motion is: (1) granted, then the moving lawyer will receive all numerical points possible; (2) granted in part and denied in part, then the moving and non-moving lawyer will receive a percentage of the numerical points possible; or (3) denied, then the non-moving lawyer defending against the motion will receive all of the numerical points possible.

The present invention may similarly allocate numerical point totals for written opinions at the federal appellate level. For example, if the appellant's brief causes a: (1) reversal of the decision below, then the appellant's lawyer will receive most or all of the numerical points possible, or (2) affirmance of the decision below, then the appellee's lawyer will receive most or all of the numerical points possible.

Furthermore, for federal appellate courts, an embodiment of the invention may account for the number of judges joining the majority opinion. For example, a written opinion entered by a United States Circuit Court of Appeals will often be decided by a panel of three judges. Specifically, the numerical point total associated with these written opinions may be allocated to lawyers based on the strength of the written opinion. For instance, a 2-1 decision reversing the decision below would assign 200 points to the appellant's lawyer, while 100 points would be assigned to the appellee's lawyer. A further embodiment may allocate numerical point totals associated with a written opinion entered by the Supreme Court of the United States in a similar manner to how numerical point totals may be allocated for written opinions entered by a United States Circuit Court of Appeals. For example, the numerical point totals associated with these written opinion may also be allocated to the lawyer based on the strength of the written opinion. Thus, an 8-1 decision affirming the decision below would assign 400 points to the appellee's lawyer, while 50 points would be assigned to the appellant's lawyer.

Another embodiment of the invention also takes into account the specific lawyer that authored the court document that resulted in the written opinion when a number of lawyers represent the same party. It is not uncommon for several lawyers to represent the same party in a single lawsuit. Notwithstanding this, it is also common for motion papers and appellate briefs to be limited to a small number of lawyers who sign the court document. In this circumstance, a further embodiment will allocate the numerical point values associated with the written opinion only to those lawyers who are signatories to the court document filed with the court that results in the written opinion.

Step 20 assigns a ranking to each lawyer and law film in the candidate pool database based on, for example: (1) the total points assigned to the lawyer or law firm, or (2) based on the lawyer's or law firm's favorable written opinion percentage (i.e., total points/total points possible). An embodiment of the present invention may then be used to compare the lawyer's or law firm's ranking with all other lawyers in the candidate pool database. A further embodiment may further rank lawyers and law firms based on sub-groups divided into specific areas of federal law (e.g., appellate practice, antitrust law, employment law, intellectual property law, securities law, or tax law), geographical locations (e.g., Florida or Broward County), or specific federal courts (e.g., the United States District Court for the Eastern District of Michigan).

In one embodiment, the system and method for identifying the accomplishments within the legal profession for lawyers who practice in federal court, described in step 12 through step 20, is made accessible to lawyers and other interested parties via an internet website (see, e.g., www.federal-list.com). Specifically, an internet server provides access to the candidate pool database stored on a local device. This internet server then allows a user to access and interact with the candidate pool database and rankings contained on the local device through the use of an internet browser that is contained on the user's own computer, smart phone, tablet, or other internet capable device.

The present invention has been described with reference to the specific embodiments herein for those skilled in the art and will be subject to modifications without departing from the true spirit and scope of the invention. The terms and descriptions used herein are set forth by way of illustration only and are not meant as limitations. Those skilled in the art will recognize that these and other variations are possible and yet will still remain within the spirit and scope of the invention as defined in the following claims and their equivalents.

What is claimed:

1. A system and method for identifying accomplishment in the legal profession for lawyers who litigate cases in federal courts compromising of creating a candidate pool database by researching, monitoring, and identifying the performance of lawyers practicing in federal court based on “written opinions,” wherein the system and method identifies substantive “written opinions,” as the term is used in Section 205 of the E-Government Act of 2002, 44 U.S.C. § 101, et seq., by researching electronic court filing systems for court documents that federal judges may themselves identify as “written opinions;” wherein the system and method retrieves these “written opinions” from electronic court filing systems, such as court websites; wherein the system and method evaluates court documents submitted by lawyers to determine if court documents should be reclassified as a “written opinions” based on objective standards, including whether the specific court document includes a statement of facts, points of law, rationale, dicta or other indicia of reasoning; wherein the system and method inputs information about lawyers and law firms associated with these “written opinions” into a candidate pool database during an evaluation period.

2. The system and method as in claim 1, wherein the system and method evaluates and compares the lawyers and law firms that are within the candidate pool database based on associated “written opinions,” wherein the system and method establishes a formula that assigns a numerical point total to “written opinions” based on the importance and significance of each particular “written opinion,” such as whether a “written opinion” grants, denies, affirms, or reverses requested relief that concludes, or substantially concludes, the litigation or has substantial legal significance within the legal community, such as a nationwide injunction or creates binding precedent; wherein the system and method evaluates “written opinions” to determine the lawyers and law firms that obtained favorable relief in associated written opinions, such as a motion or brief being granted, denied, affirmed, or reversed; wherein the system and method assigns the numerical point totals of “written opinions,” or a percentage thereof, to the lawyers and law firms associated with the favorable relief provided by the grant, denial, affirmance, or reversal contained within a “written opinion;” wherein the system and method ranks lawyers and law firms within the candidate pool database based on their assigned point totals, both overall, and within sub-groups based on areas of law, geographical location, or a specific federal court.

3. The method as in claim 2, wherein the system and method comprises of a website that is used to provide real-time access to the candidate pool database and rankings to end users.
